(19) United States
(12) Patent Application Publication
(10) Pub. No.: US 2015/0205667 A1
(43) Pub. Date: Jul. 23, 2015

(54) METHOD AND SYSTEM FOR SERVICE-AWARE DATA PLACEMENT IN A STORAGE SYSTEM

(71) Applicant: Jeffrey S. Bonwick, Los Altos, CA (US)

(72) Inventor: Jeffrey S. Bonwick, Los Altos, CA (US)

(73) Assignee: DSSD, INC., Menlo Park, CA (US)

(21) Appl. No.: 14/162,310

(22) Filed: Jan. 23, 2014

(51) Int. Cl. G06F 11/10

(52) U.S. Cl. CPC G06F 11/1076

(57) ABSTRACT

A method and system for service-aware data placement. The method includes receiving a service notification specifying a target SD and, after receiving the service notification, receiving a request to write data, writing a RAID stripe that includes data blocks and a parity block, where the parity block is not stored on the target SD and none of the data blocks is stored on the target SD. The method further includes performing a modified garbage collection operation that includes identifying a live RAID stripe with includes N data blocks, writing a new RAID stripe that includes N−1 data blocks and a second parity block, where the second parity block and none of the N−1 data blocks is stored on the target SD, and issuing a removal notification that indicates that the target SD may be removed.

### BACKGROUND

In order to protect against potential loss of data in a storage system, it is often advantageous to implement a replication scheme. Current replication schemes do not take hardware service schedules of the storage system into account when writing data and parity values.

### SUMMARY

In general, in one aspect, the invention relates to a non-transitory computer readable medium including instructions, which when executed by a processor perform a method, the method includes receiving a service notification specifying a target storage device (SD), after receiving the service notification: receiving a request to write data to persistent storage, where the persistent storage comprises the SD, in response to the request, writing a Redundant Array of Independent Disks (RAID) stripe to persistent storage, where the RAID stripe comprises first data blocks and a first parity block, where at least one of the first data blocks comprises a portion of the data, wherein the first parity block comprises a first parity value calculated using the first data blocks, and where the first parity block is not stored on the target SD and where none of the first data blocks is stored on the target SD, performing a modified garbage collection operation, wherein the modified garbage collection operation includes: identifying a live RAID stripe in the persistent storage, where the live RAID stripe comprises N second data blocks and a second parity block, where at least a portion of the live RAID stripe is located on the target SD, writing a new RAID stripe to a new location in the persistent storage, where the new RAID stripe comprises N−1 third data blocks, where at least one of the N−1 third data blocks comprises a copy of data in at least one of the second data blocks, where the new RAID stripe comprises a third parity block, where the third parity block comprises a second parity value calculated using the N−1 third data blocks, where the third parity block is not stored on the target SD, and none of the N−1 third data blocks is stored on the target SD, and issuing a removal notification when the modified garbage collection operation is completed, where the removal notification indicates that the target SD may be removed from the persistent storage.

In general, in one aspect, the invention relates to a system, including a storage array that includes N+M storage devices (SDs), and a storage controller operatively connected to the storage array and configured to: identify a target SD to remove, after identifying the target SD, where the target SD is one of the plurality of SDs, receive a request to write data to the storage array, in response to the request, write a Redundant Array of Independent Disks (RAID) stripe that includes N−1 data blocks and M parity blocks to the storage array, where none of the N−1 data blocks is stored on the target SD and none of the M parity blocks is stored on the target SD, perform a modified garbage collection operation, where the modified garbage collection operation includes: identifying a live RAID stripe in the storage array, where the live RAID stripe comprises second data and consists of N second data blocks and M second parity blocks, writing a new RAID stripe to a new location in the storage array, where the new RAID stripe consists of N−1 third data blocks and M third parity blocks, where at least one of the N−1 third data blocks comprises a copy of data in at least one of the N second data blocks, and issue a removal notification when the modified garbage collection operation is completed, where the removal notification indicates that the target SD may be removed from the storage array.

Other aspects of the invention will be apparent from the following description and the appended claims.

### BRIEF DESCRIPTION OF DRAWINGS

FIG. 1 shows a system in accordance with one embodiment of the invention.

FIG. 2 shows RAID stripes in accordance with one or more embodiments of the invention.

FIG. 3 shows data structures in accordance with one embodiment of the invention.

FIG. 4 shows a flowchart implementing a RAID write operation in accordance with one or more embodiments of the invention.

FIG. 5 shows a flowchart for implementing service-aware data placement in accordance with one or more embodiments of the invention.

FIG. 6 shows a flowchart for the implementing the modified RAID write operation in accordance with one or more embodiments of the invention.

FIGS. 7A-7B shows a flowchart for implementing a modified garbage collection operation in accordance with one or more embodiments of the invention.

FIGS. 8A-8B show an example in accordance with one or more embodiments of the invention.

### DETAILED DESCRIPTION

Specific embodiments of the invention will now be described in detail with reference to the accompanying figures. In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

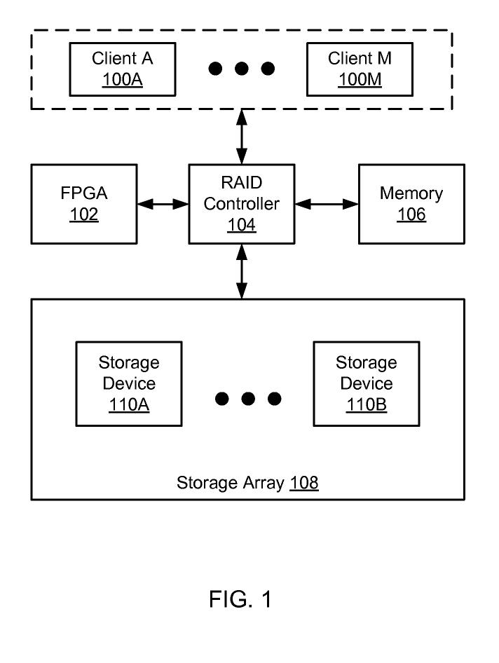

In the following description of FIGS. 1-8B, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

In general, embodiments of the invention relate to storing data in a storage array using a RAID scheme. More specifically, the RAID scheme uses information about storage devices that are to be removed and/or replaced when determining RAID stripe geometry for new and live RAID stripes.

For purposes of this invention, the term “RAID” as used herein refers to “Redundant Array of Independent Disks.” While “RAID” refers to any array of independent disks, embodiments of the invention may be implemented using any type of persistent storage device.

FIG. 1 shows a system in accordance with one embodiment of the invention. As shown in FIG. 1, the system includes one or more clients (100A, 100M), a RAID controller (104), memory (106), optionally a Field Programmable Gate Array (FPGA) (102), and a storage array (108).

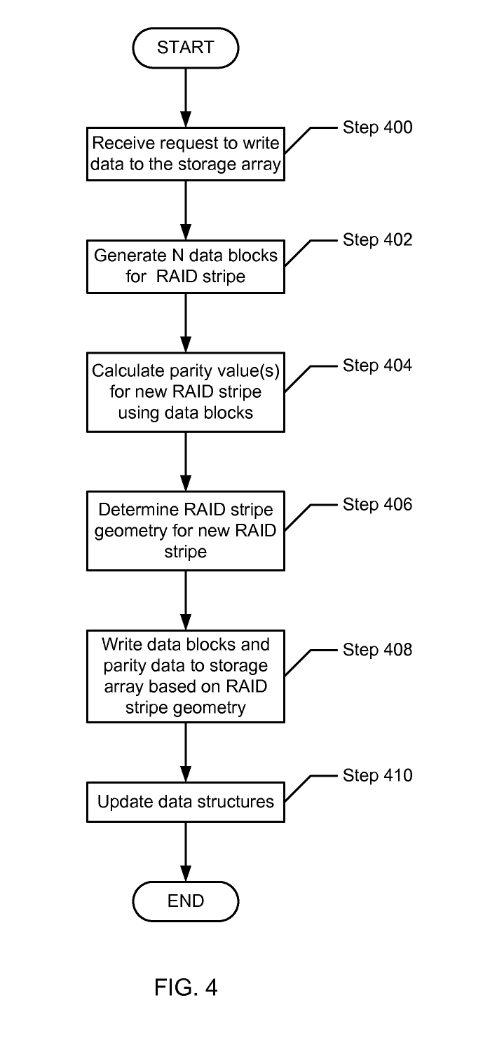

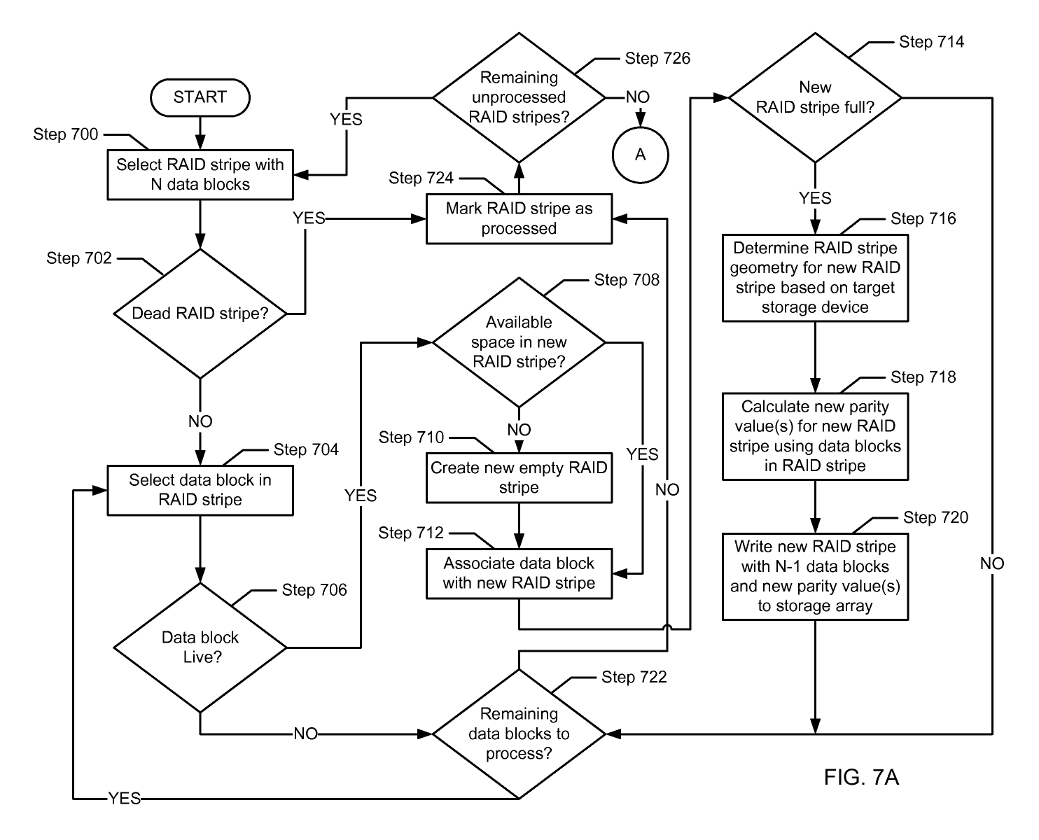

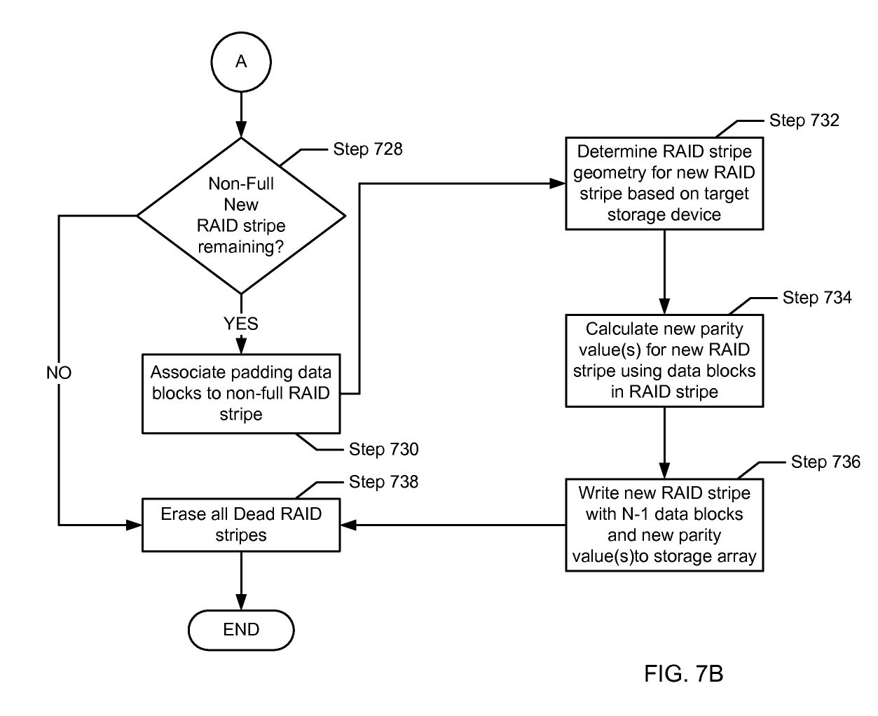

In one embodiment of the invention, a client (100A, 100M) is any system or process executing on a system that includes functionality to issue a read request or a write request to the RAID controller (104). In one embodiment of the invention, the clients (100A, 100M) may each include a processor (not shown), memory (not shown), and persistent storage (not shown). In one embodiment of the invention, the RAID controller (104) is configured to implement a RAID scheme, which includes writing data to the storage array (108) in a manner consistent with embodiments described in FIGS. 4-7, and performing garbage collection operations in accordance with embodiments described in FIG. 7. Further, the RAID controller includes functionality to read data (including reconstructing data) from the storage array (108). In one embodiment of the invention, the RAID controller (104) includes a processor configured to execute instructions to implement one or more embodiments of the invention, where the instructions are stored on a non-transitory computer readable medium (not shown) that is located within or that is operatively connected to the RAID controller (104). Alternatively, the RAID controller (104) may be implemented using hardware. Those skilled in the art will appreciate that the RAID controller (104) may be implemented using any combination of software and/or hardware.

In one embodiment of the invention, the RAID controller (104) is operatively connected to memory (106). The memory (106) may be any volatile memory including, but not limited to, Dynamic Random-Access Memory (DRAM), Synchronous DRAM, SDR SDRAM, and DDR SDRAM. In one embodiment of the invention, the memory (106) is configured to temporarily store various data (including parity data) prior to such data being stored in the storage array.

In one embodiment of the invention, the FPGA (102) (if present) includes functionality to calculate parity values (e.g., P parity value, Q parity value) for purposes of storing data in the storage array (108) and/or functionality to perform various calculations necessary to recover corrupted data stored using the RAID scheme. The RAID controller (104) may use the FPGA (102) to offload the processing of various data in accordance with one or more embodiments of the invention.

In one embodiment of the invention, the storage array (108) includes one or more storage devices (SDDs) (110A, 110B). Each storage device includes persistent storage media. Examples of storage devices include, but are not limited to, magnetic memory devices, optical memory devices, phase change memory devices, solid state memory devices, tape drives, any other suitable type of persistent memory device, or any combination thereof.

Those skilled in the art will appreciate that while FIG. 1 shows an FPGA, the invention may be implemented without an FPGA. Further, those skilled in the art will appreciate that other components may be used in place of the FPGA without departing from the invention. For example, the invention may be implemented using an Application Specific Integrated Circuit(s) (ASIC), a graphics processing unit(s) (GPU), a general purpose processor(s), any other hardware device capable of calculating parity values for purposes of storing data in the storage array and/or performing various calculations necessary to recover corrupted data stored using the RAID scheme, any devices that include a combination of hardware, firmware, and/or software configured to calculate parity values for purposes of storing data in the storage array (108) and/or to perform various calculations necessary to recover corrupted data stored using the RAID scheme, or any combination thereof.

Those skilled in the art will appreciate that the invention is not limited to the configuration shown in FIG. 1.

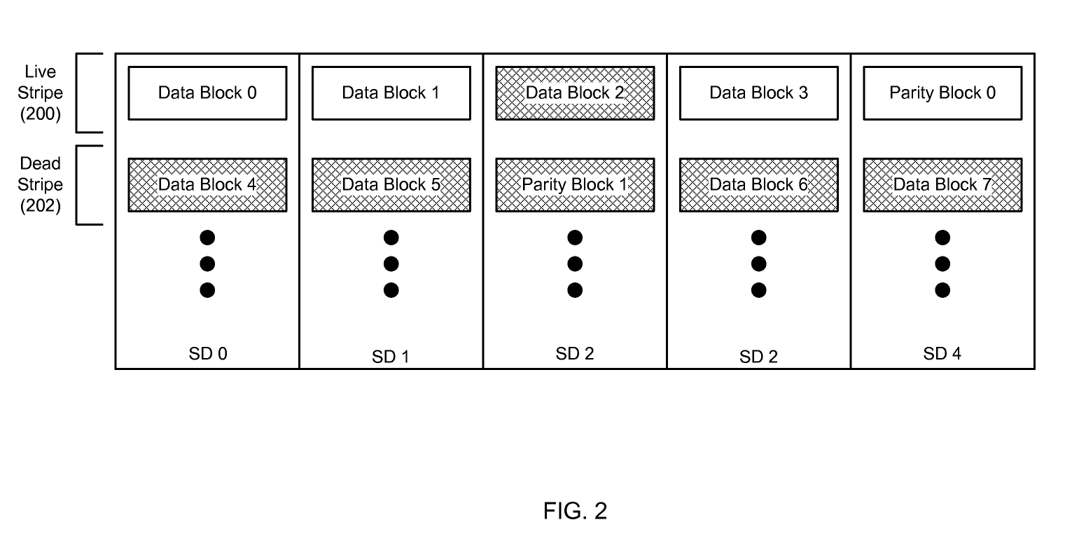

FIG. 2 shows RAID stripes in accordance with one or more embodiments of the invention. Each RAID stripe includes data blocks and parity blocks. A data block corresponds to a portion of a RAID stripe that is located on a storage device that includes data (as opposed to parity values). A parity block corresponds to a portion of the RAID stripe that is located on a storage device that includes a parity value (or one of the parity values) for the RAID stripe. Each RAID stripe includes data blocks and one or more parity blocks.

In one embodiment of the invention, each block (i.e., data blocks and parity blocks) may be a dead block or a live block. A dead block is a block that includes stale data or data that is otherwise marked to be erased. Data may be considered stale when an updated copy of the data is stored in another live block in the storage array. The data in the dead block is not used to service read requests. In one embodiment of the invention, a live block is a block that includes at least some data that is actively being used by clients and/or the storage controller. The data in the live block is used to service read requests.

Each RAID stripe in the system is either a live stripe (200) or a dead stripe (202). A RAID stripe is a dead stripe if it only includes dead blocks (e.g., data blocks 4-7 and parity block 1). A RAID stripe in the storage array is a live stripe (200) if it includes at least one live block.

As shown in FIG. 2, the RAID stripes (200, 202) include data blocks and parity blocks. The number of data blocks and parity blocks may vary based upon the RAID scheme used to generate the RAID stripes. For example, if the RAID stripe is generated in accordance with RAID-5, then the RAID stripe may include four data blocks and one parity block. In another example, if the RAID stripe is generated in accordance with RAID-6, then the RAID stripe may include four data blocks and two parity blocks (e.g., a parity block with a P parity value and a second parity block with a Q parity value). RAID stripes in the storage array may all be implemented using the same parity scheme. Alternatively, RAID stripes in the storage array may be implemented using different RAID schemes.

In one embodiment of the invention, the P parity value is a Reed-Solomon syndrome that is generated using a P parity function. The P Parity function may correspond to any function that can generate a Reed-Solomon syndrome. In one embodiment of the invention, the P parity function is an XOR function.

In one embodiment of the invention, the Q parity value is a Reed-Solomon syndrome that is generated using a Q parity function. The Q Parity function may correspond to any function that can generate a Reed-Solomon syndrome. In one embodiment of the invention, a Q parity value is a Reed-Solomon code. In one embodiment of the invention, Q=g⁰·D₀+g¹·D₁₊g²·D_{2+ . . . +}gⁿ⁻¹·Dₙ₋₁, where Q corresponds to any one of the Q parity values described in the invention, g is a generator of the field, and the value of D corresponds to the data (stored in the data blocks in the corresponding RAID stripe).

In one embodiment of the invention, the RAID stripe geometry defines the location of each of the blocks in a RAID stripe. For example, referring to live stripe (200), the RAID geometry may specify the following: (i) RAID scheme−RAID 5, and (ii) that the parity block is located on SD 4. Similarly, for the dead stripe (202), the RAID geometry may specify the following: (i) RAID scheme−RAID 5 and (ii) that the parity block is located on SD 2. Depending on the specific implementation of the SD, the RAID stripe geometry may also include the location of the specific block(s) within the SD that correspond to the parity block(s).

Using this information the storage controller (or another component in the system) may determine the location of the data blocks in the storage array for the live stripe (200) and dead stripe (202). The stripe geometry may include additional information (e.g., data block locations) and/or other information without departing from the invention.

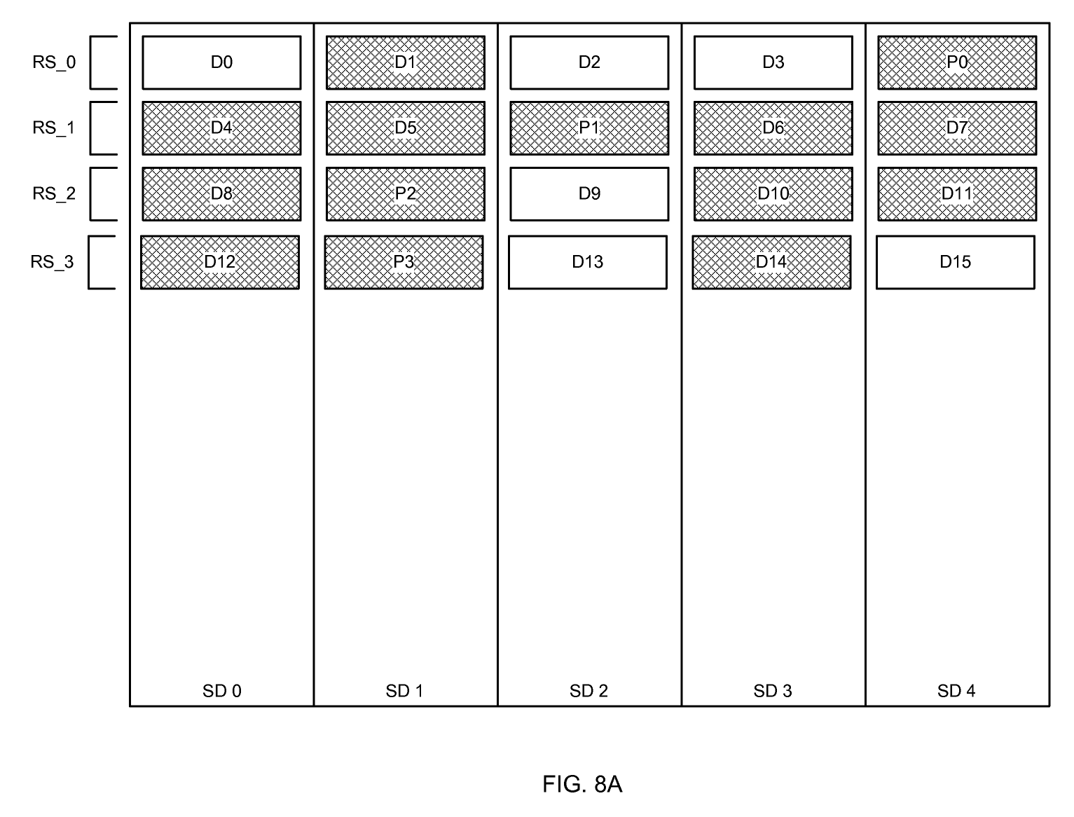

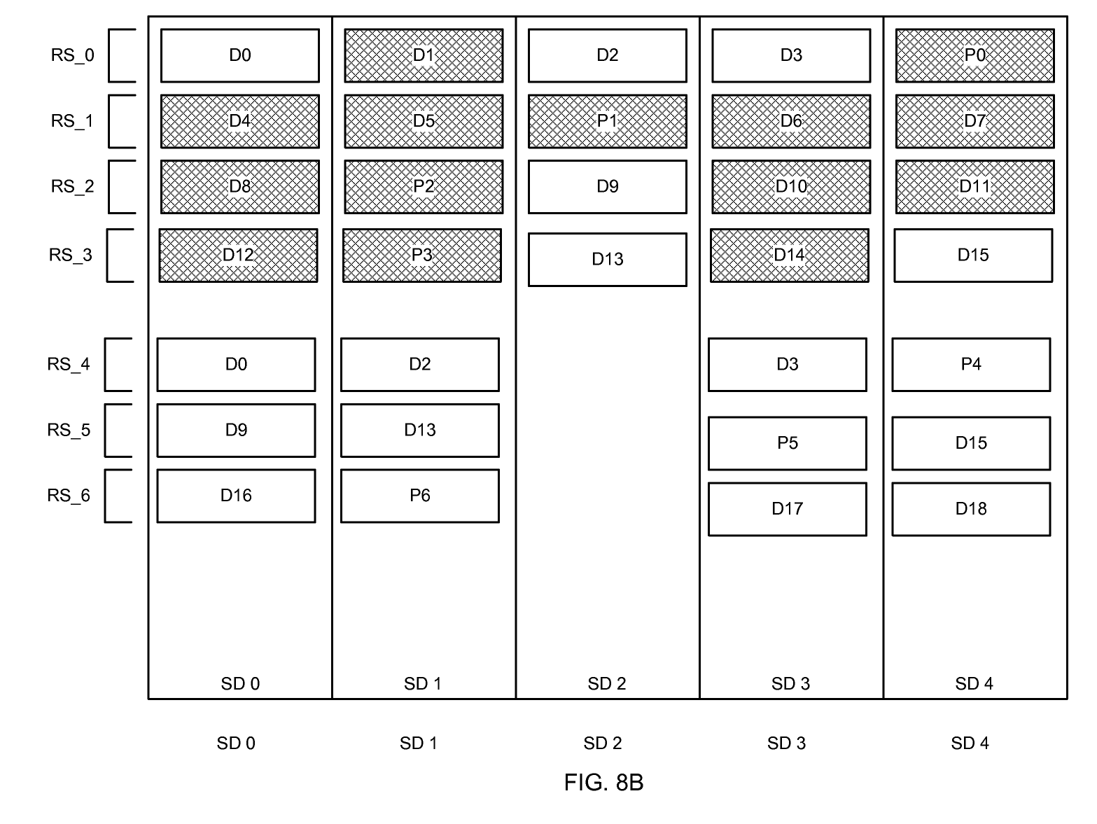

In one embodiment of the invention, each block in the RAID stripe is located on a different SD. Further, the width of each RAID stripe in the storage array may be the same and span the entire storage array (e.g., 5 SDs in FIG. 2). In another embodiment of the invention, the RAID stripe may not span the entire storage array (see e.g., FIGS. 8C-8D)

Embodiments of the invention may be implemented using different RAID schemes (e.g., RAID-4, RAID-5, RAID-6, multi-dimensional RAID, etc.) and different stripe widths without departing from the invention. Further, a given storage array may concurrently have stored therein RAID stripes of different widths stored using different RAID schemes.

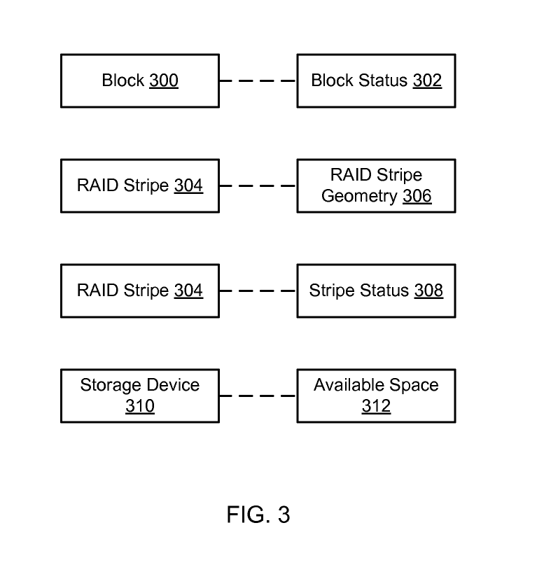

FIG. 3 shows data structures in accordance with one embodiment of the invention. In one embodiment of the invention, the RAID controller includes one or more data structures to implement embodiments of the invention.

In one embodiment of the invention, a block status (302) is maintained for each block (300) in the storage array. The block status (302) indicates whether the block is a live block or a dead block. In one embodiment of the invention, a RAID stripe geometry (306) is maintained for each RAID stripe (304) stored in the storage array. Further, a stripe status (308), which indicates whether the RAID stripe (304) is a live stripe or a dead stripe, is maintained for each RAID stripe (304). In addition, the RAID controller may also track available space (312) in each storage device (310). The available space denotes how much of the storage device is available to store blocks (data or parity). The available space may include (i) currently unused space and/or (ii) space that is currently being used but that may be overwritten with new blocks (data or parity).

Turning to the flowcharts, while the various steps in the flowchart are presented and described sequentially, one of ordinary skill will appreciate that some or all of the steps may be executed in different orders, may be combined or omitted, and some or all of the steps may be executed in parallel. In one embodiment of the invention, one or more steps shown in FIGS. 4-7B may be performed in parallel with one or more of the other steps shown in FIGS. 4-7B.

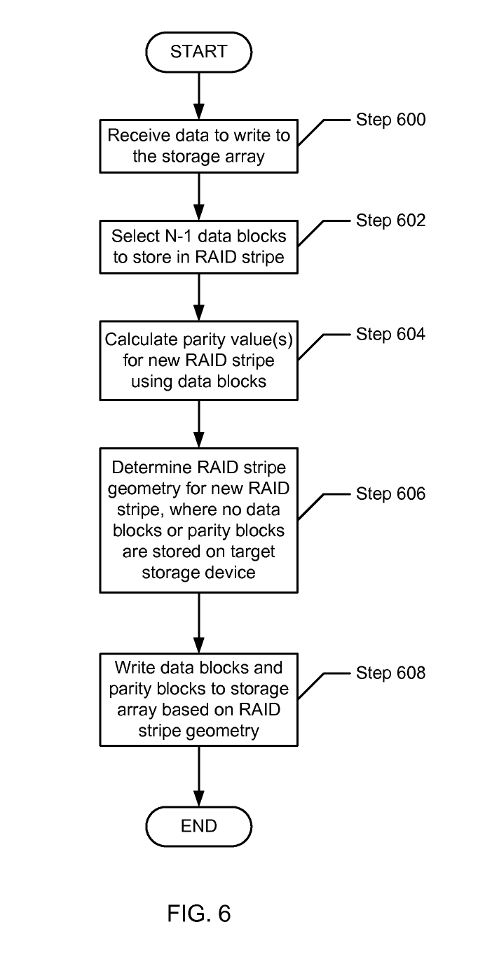

FIG. 4 shows a flowchart implementing a RAID write operation in accordance with one or more embodiments of the invention. More specifically, FIG. 4 shows normal RAID write operations prior to a target SD being identified (see FIG. 6).

In Step 400, a request to write data to the storage array is received. The request may include the data to be stored or may include a reference to the data to be stored. The request may take any form without departing from the invention. In Step 402, N data blocks are generated to store in a RAID stripe (see e.g., FIG. 2). A data block corresponds to a portion of the data that is to be stored in the storage array. The number of data blocks for the RAID stripe is based on the RAID scheme upon which the RAID stripe is based. In Step 404, one or more parity values for the new RAID stripe are calculated using the data blocks. The number of parity values depends on the RAID scheme upon which the RAID stripe is based. For example, if the RAID stripe is generated based on RAID-6, then there are two parity values calculated: P parity value and a Q parity value. The result of Step 404 is a set of parity blocks. In Step 406, the RAID stripe geometry (see FIG. 2) is determined for the RAID stripe. The RAID stripe geometry may correspond to any RAID stripe geometry. Specifically, the parity value(s) may be placed on any SD in the storage array.

In Step 408, the data blocks and parity blocks are written to the storage array as a RAID stripe in accordance with the RAID stripe geometry (determined in Step 406). In Step 410, the data structures (e.g., the data structures in FIG. 3) are updated to reflect that the new RAID stripe has been written to the storage array. For example, Step 410 may include (i) storing the RAID stripe geometry for the new RAID stripe and (ii) updating the amount of available space in each of the storage devices to which at least one block in the new RAID stripe was written.

Concurrently with the execution of the process shown in FIG. 4, the storage controller may also be performing garbage collection operations. In general, garbage collection operations include (i) identifying live RAID stripes that have zero or more dead data blocks, (ii) generating new RAID stripes using live data blocks from the RAID stripe identified in (i), (iii) writing the new RAID stripes to available locations in the storage array, and (iv) erasing or otherwise reclaiming all locations in the storage array that include dead RAID stripes or RAID stripes identified in (i).

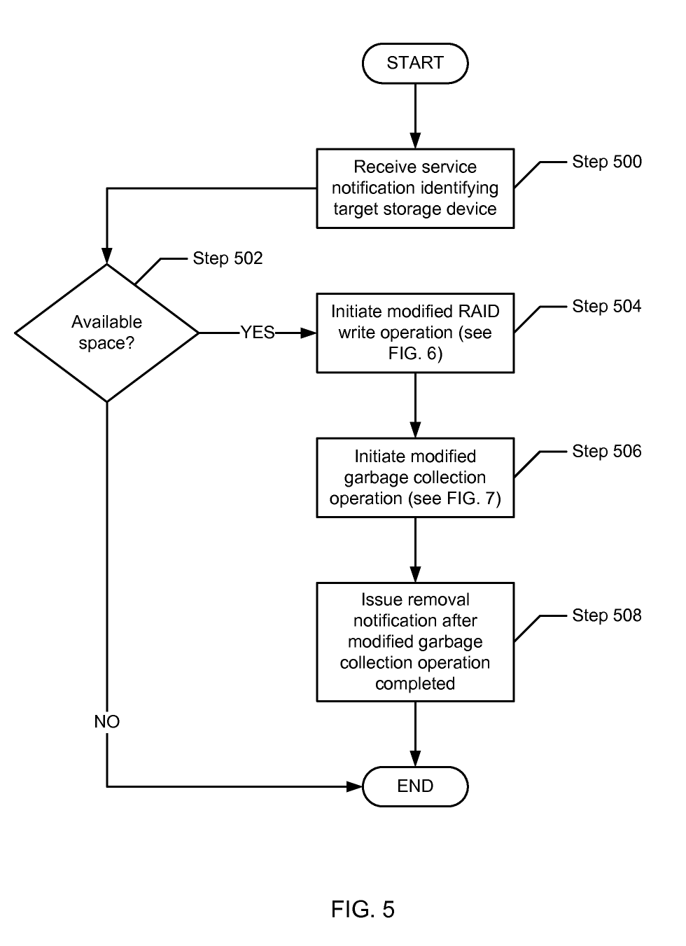

FIGS. 5-7B show flowcharts directed to the operation of the storage controller after a target SD is identified.

Turning to FIG. 5, FIG. 5 shows a flowchart for implementing service-aware parity placement in accordance with one or more embodiments of the invention. In Step 500, a service notification request identifying a target SD is received. The target SD corresponds to an SD in the storage array that (i) is scheduled to be replaced based on an SD service schedule (e.g., each SD is replaced after they have been in service for a certain period of time), (ii) is to be replaced based upon input from a user (e.g., system administrator), or (iii) is experiencing error events (e.g., failed write operations, failed read operations, etc.) that are above an error event threshold. The error event threshold may be set based upon (a) user input, (b) default values, and/or (c) historical information about the storage array and/or the SD. The service notification may be issued and/or received by the storage controller based on items (i), (ii) and/or (iii) listed above. Alternatively, the storage controller may perform the remainder of the steps based on items (i), (ii) and/or (iii) listed above without receiving a service notification. In another embodiment of the invention, one process (or set of processes) executing in the storage controller may, based on items (i), (ii) and/or (iii), generate a service notification, which is then received by the process (or set of processes) in the storage controller executing the steps in FIG. 5.

In Step 502, a determination is made about whether there is available space in the storage array to perform the remaining steps in FIG. 5. This determination made be made using the data structures in FIG. 3. Specifically, if the RAID stripe includes N data blocks, then in order for there to be sufficient available space to perform the remaining steps in FIG. 5, there must be sufficient space in the storage array to store the N data blocks N−1 storage devices. For example, consider the scenario in which there are two RAID stripes in the storage array with five storage devices implementing RAID-5, where each RAID stripe includes four data blocks and one parity block. Accordingly, there are two blocks (data or parity) on each of the five storage devices. In order to determine whether there is enough available space, each storage device (other than the target storage device) must have sufficient space to store three blocks (either data or parity). If there is sufficient available space, the process proceeds to Step 504; otherwise the process ends.

In Step 504, the modified RAID operation is initiated (see FIG. 6). The modified RAID operation is only performed when a write request is received between Step 500 (or after the target SD is identified) and the issuance of the removal notification in Step 508. In Step 506, the modified garbage collection operation is performed (see FIG. 7A-7B). In one embodiment of the invention, the modified garbage collection operation is always performed while the modified RAID operation is only performed when a write request is received. As such, if no write requests are received between steps 500 and the completion of the modified garbage collection operation, then step 504 is not performed. As discussed above, steps 504 and 506 may be performed concurrently. In Step 508, once the modified garbage collection operation is completed, the storage controller (or a process executing thereon) may issue a removal notification indicating that the target SD may be physically removed from the storage array. After step 508, the storage controller services write requests in accordance with FIG. 4 and performs garbage collection operations (and not the modified garbage collection operation) as described above until another target SD is identified.

FIG. 6 shows a flowchart for the implementing the modified RAID write operation in accordance with one or more embodiments of the invention.

In Step 600, a request to write data to the storage array is received. The request may include the data to be stored or may include a reference to the data to be stored. The request may take any form without departing from the invention. In Step 602, data blocks are generated to store in the RAID stripe (see e.g., FIG. 2). A data block corresponds to a portion of the data that is to be stored in the storage array. With respect to Step 602, the number of data blocks is based on the number of data blocks that are in the RAID stripe. If the storage array includes N storage devices, the maximum number of blocks (data blocks+parity blocks) in the RAID stripe is N−1. Further, if there are X parity blocks in the RAID stripe, then the maximum number of data blocks in the RAID stripe is N−1−X. For example, if there are five storage devices in the storage array and there is one parity block in the RAID stripe, then the maximum number of data blocks in the RAID stripe is 5−1−1=3.

In Step 604, one or more parity values for the new RAID stripe are calculated using the data blocks. The number of parity values depends on the RAID scheme upon which the RAID stripe is based. For example, if the RAID stripe is generated based on RAID-6, then there are two parity values calculated: P parity value and a Q parity value. The result of Step 604 is one or more parity blocks. In Step 606, the RAID stripe geometry (see FIG. 2) is determined for the new RAID stripe. The RAID stripe geometry may correspond to any RAID stripe geometry that does not place any data blocks or parity blocks on the target SD. Continuing with the discussion of FIG. 6, in Step 608, the data blocks and parity blocks are written as a RAID stripe to the storage array in accordance with the RAID stripe geometry (determined in Step 606).

FIGS. 7A-7B shows a flowchart for implementing a modified garbage collection operation in accordance with one or more embodiments of the invention. In Step 700, a RAID stripe is selected. The RAID stripe may be any RAID stripe in the storage array that is present at the time the modified garbage collection operation is initiated. The process described in FIG. 7A-7B is not performed on RAID stripes that are written to the storage array (as part of the modified garbage collection operation or as part of the modified RAID write operation (see FIG. 6)) after the modified garbage collection operation is initiated. The RAID stripe selected in Step 700 includes N data blocks.

In Step 702, a determination is made about whether the selected RAID stripe is a dead stripe. If the selected RAID stripe is a dead stripe, then the process proceeds to step 724; otherwise, the process proceeds to step 704. In Step 704, a data block in the RAID stripe is selected. In Step 706, a determination is made about whether the selected data block is live. If the selected data block is live, the process proceeds to Step 708; otherwise, the process proceeds to Step 722.

In Step 708, a determination is made about whether there is space available to store the selected data block in the new RAID stripe. Said another way, a determination is made about whether there is a new RAID stripe that is currently being filled with data blocks as part of the modified garbage collection operation (see e.g., FIG. 8A-8B). If there is space available to store the selected data block in the new RAID stripe, the process proceeds to Step 712; otherwise, the process proceeds to Step 710. In one embodiment of the invention, the new RAID stripe is not full if there is less than N−1 data blocks associated with the new RAID stripe, where the RAID stripe (when full) includes N−1 data blocks and M parity blocks (where e.g., N≧4 and M≧1).

In Step 710, when there is no space available to store the selected data block in the new RAID stripe, a new RAID stripe is created. In one embodiment of the invention, at the time the new RAID stripe is created, the RAID stripe does not include any data blocks or parity blocks. In Step 712, the data block (selected in Step 704) is associated with a new RAID stripe (i.e., the empty new RAID stripe created in Step 710 or another new RAID stripe that includes at least one other data block and is not full at the time Step 708 is performed).

In Step 714, a determination is made about whether the new RAID stripe is full (i.e., is the new RAID stripe associated with N−1 data blocks). If the new RAID stripe is full, the process proceeds to Step 716; otherwise, the process proceeds to Step 722.

In Step 716, a new RAID stripe geometry is generated for the selected RAID stripe in which none of the blocks in the RAID stripe are to be stored on the target SD. In Step 718, a new parity value(s) is calculated for the parity block(s) using the data blocks associated with the new RAID stripe. In Step 720, the data blocks and the parity block(s) (which include the parity value(s)) are written as a RAID stripe (with N−1 data blocks) in the storage array in accordance with the RAID stripe geometry determined in Step 716. The process then proceeds to Step 722.

In Step 722, a determination is made about whether there are additional data blocks remaining to process in the selected RAID stripe. If there are additional data blocks remaining to process in the selected RAID stripe, the process proceeds to Step 704; otherwise, the process proceeds to Step 724.

In Step 724, the RAID stripe (selected in Step 700) is marked as processed. In Step 726, a determination is made about whether there are remaining RAID stripes to process in the storage array. If there are remaining RAID stripes to process in the storage array, the process proceeds step 700; otherwise, the process proceeds to Step 728.

In Step 728, a determination is made about whether there are any non-full new RAID stripes remaining Said another way, a determination is made about whether there is a non-full RAID stripe that includes data blocks that need to be stored in the storage array. If there are any non-full new RAID stripes remaining, the process proceeds to Step 730; otherwise, the process proceeds to Step 738.

In Step 730, one or more padding data blocks are associated with the RAID Stripe (identified in Step 728) in order to have a total of N−1 data blocks associated with the RAID stripe. Padding data blocks are data blocks that include, e.g., blocks that include all zeros or all ones, so as to not impact the parity value(s) generated using the non-padding data blocks in the RAID stripe.

In Step 732, a new RAID stripe geometry is determined for the selected RAID stripe in which none of the blocks in the RAID stripe are to be stored on the target SD. In Step 734, a new parity value(s) is calculated for the parity block(s) using the data blocks associated with the new RAID stripe. In Step 736, the data blocks and the parity block(s) (which include the parity value(s)) are written as a RAID stripe (that includes N−1 data blocks) in the storage array in accordance with the RAID stripe geometry determined in Step 732. The process then proceeds to Step 738.

In Step 738, all RAID stripes that existed in the storage array prior to the initiation of the modified garbage collection operation have been processed and, accordingly, all processed RAID stripes are erased. Once all processed RAID stripes are erased, a removal notification may be issued, which indicates that the target SD may be removed. The removal notification may be sent to a user (e.g., a system administrator) indicating that the target SD may be removed from the storage array. Though not required, all dead blocks may also be erased when the processed RAID stripes are being erased.

In one embodiment of the invention, the result of the process in FIG. 7A-7B results in a set of new RAID stripes in which none of blocks (data or parity) associated with the new RAID stripe are located on the target SD.

FIGS. 8A-8B show an example in accordance with one or more embodiments of the invention. The example is not intended to limit the scope of the invention.

Turning to FIG. 8A, consider a scenario in which the storage array has five storage devices (SD0-SD4) and that a service notification has been received which indicates that SD2 needs to be removed. FIG. 8A shows the state of the storage array at the time the modified garbage collection operation is initiated.

At this stage, the storage controller initiates the modified garbage collection operation as described in FIG. 7A-7B. Specifically, referring to FIG. 8A, RAID Stripe RS_0 through RAID Stripe RS_3 each include four data blocks and one parity block. More specifically, RAID Stripe RS_0 is a live RAID stripe and includes live data blocks D0, D2, and D3. RAID Stripe RS_1 is a dead stripe. RAID Stripe RS_2 is a live RAID stripe that includes live data block D9. Finally, RAID Stripe RS_3 is a live RAID stripe that includes live data blocks D13 and D15.

RS_0 through RAID Stripe RS_3 are processed in accordance with FIGS. 7A-7B. Specifically, the live data blocks D0, D2, and D3 are combined to form a new RAID stripe RS_4. (See FIG. 8B). Further, live data blocks D9, D13 and D15 are combined to form a new RAID stripe RS_5. As shown in FIG. 8B, the new RAID stripes (RS_4 and RS_5) have three data blocks (instead of four data blocks). With respect to RAID Stripe RS_1, no data blocks in RAID Stripe RS_1 are rewritten in any of the new RAID stripes as all data blocks in RS_1 are dead.

In this example while the modified garbage collection operation is being performed (i.e., after RAID Stripe RS_4 and RAID Stripe RS_5 have been written to the storage array but prior to the RAID Stripe RS_0 through RAID Stripe RS_3 being erased), the storage controller (not shown) receives a request to write new data as a RAID stripe to the storage array. The new data is written to the storage array in accordance with FIG. 6 (Step 606), where the RAID stripe geometry specifies that the parity block (P6) is to be located on SD1. RAID Stripe RS_6 is subsequently written to the storage array.

At this stage, all RAID stripes that existed in the storage array at the time the modified garbage collection operation was initiated have been processed. Accordingly, referring to FIG. 8B, all processed RAID stripes (i.e., RAID Stripes RS_0-RS_3) may be erased and SD 2 may subsequently be removed. SD 2 may be removed prior to the dead blocks being erased without departing from the invention.

Those skilled in the art will appreciate that while the invention has been described with respect to a single dimension RAID scheme, embodiments of the invention, may be extended to any multi-dimensional RAID scheme. For example, embodiments of the invention may be extended to the multi-dimensional RAID scheme described in U.S. Pat. No. 8,316,260 (which is hereby incorporated by reference).

In one or more embodiments of the invention, after the methods shown in FIGS. 5-7B have been performed the RAID stripes that remain after the target SD has been removed have the same number of parity blocks as the RAID stripes that were present prior to the initiation of FIGS. 5-7A but each have one fewer data blocks per RAID stripe. Once the modified garbage collection process is complete, new RAID stripes written to the storage array may include the same number of data blocks as RAID stripes included prior to the initiation of the modified garbage collection operation. Further, RAID stripes may be written across all SDs. Said another way, after the completion of FIG. 5, subsequently received data may be written to the storage array in RAID stripes that include N data blocks (as compared with the N−1 data blocks in RAID stripes generated during the performance of FIG. 5).

One or more embodiments of the invention may be implemented using instructions executed by one or more processors in the system. Further, such instructions may correspond to computer readable instructions that are stored on one or more non-transitory computer readable mediums.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A non-transitory computer readable medium comprising instructions, which when executed by a processor perform a method, the method comprising:
receiving a service notification specifying a target storage device (SD), wherein the service notification is issued in response to the target SD being identified for replacement based on an SD service schedule, wherein the target SD has been in service for a certain period of time, and wherein the SD service schedule specifies that the target SD is to be replaced after the target SD has been in service for the certain period of time;
after receiving the service notification:
receiving a request to write data to persistent storage, wherein the persistent storage comprises a set of SDs and the target SD is one of the set of SDs;
in response to the request, writing a Redundant Array of Independent Disks (RAID) stripe to persistent storage, wherein the RAID stripe comprises first data blocks and a first parity block, wherein at least one of the first data blocks comprises a portion of the data, wherein the first parity block comprises a first parity value calculated using the first data blocks, and wherein the first parity block is not stored on the target SD and wherein none of the first data blocks are stored on the target SD;
performing a modified garbage collection operation, wherein the modified garbage collection operation comprises:
identifying a live RAID stripe in the persistent storage, wherein the live RAID stripe comprises N second data blocks and a second parity block, wherein at least a portion of the live RAID stripe is located on the target SD;
making a determination that the at least a portion of the live RAID stripe located on the target SD comprises a live data block;
writing, based at least in part on the determination, a new RAID stripe to a new location in the persistent storage,
wherein the new RAID stripe comprises N−1 third data blocks, wherein at least one of the N−1 third data blocks comprises a copy of data in at least one of the N second data blocks,
wherein the new RAID stripe comprises a third parity block, wherein the third parity block comprises a second parity value calculated using the N−1 third data blocks;
wherein the third parity block is not stored on the target SD, and none of the N−1 third data blocks are stored on the target SD; and
issuing a removal notification when the modified garbage collection operation is completed, wherein the removal notification indicates that the target SD may be removed from the persistent storage.

2. The non-transitory computer readable medium of claim 1, further comprising:
after a new SD is added to the persistent storage to replace the target SD:
receiving a second request to write second data to the persistent storage;
in response to the second request, writing a second RAID stripe to the persistent storage wherein the second RAID stripe comprises N fourth data blocks and a fourth parity block, wherein at least one of the N fourth data blocks comprises a portion of the second data, wherein the fourth parity block comprises a fourth parity value calculated using the N fourth data blocks, and wherein at least one of: the fourth parity block and at least one of the N fourth data blocks is stored on the new SD.

3. The non-transitory computer readable medium of claim 1, wherein the live RAID stripe was stored in the persistent storage prior to receiving the service notification.

4. The non-transitory computer readable medium of claim 3, wherein the second data blocks and the second parity block are arranged according to a RAID stripe geometry, wherein the RAID stripe geometry specifies N+1 SDs, wherein the target SD is one of the N+1 SDs, and wherein the N+1 SDs are in the set of SDs.

5. The non-transitory computer readable medium of claim 4, wherein the RAID stripe geometry specifies that the second parity block is located on the target SD.

6. The non-transitory computer readable medium of claim 4, wherein the RAID geometry specifies that one of the second data blocks is located on the target SD.

7. The non-transitory computer readable medium of claim 1, wherein the set of SDs comprises at least N30 2 SDs, wherein the target SD is one of the at least N+2 SDs.

8. The non-transitory computer readable medium of claim 7, wherein the live RAID stripe comprises a first P parity value and a first Q parity value, wherein the new RAID stripe comprises a second P parity value and a second Q parity value.

9. The non-transitory computer readable medium of claim 1, wherein the target SD is a solid state memory device.

10. The non-transitory computer readable medium of claim 1, wherein all live RAID stripes in the persistent storage are processed by the modified garbage collection operation, wherein all live RAID stripes were stored in the persistent storage prior to the service notification, and wherein the live RAID stripe is one of the live RAID stripes.

11. A system, comprising:
a storage array comprising N+M storage devices (SDs); and
a storage controller operatively connected to the storage array and configured to:
identify a target SD to remove, wherein the target SD has been in service for a certain period of time, wherein the target SD is identified based upon a SD service schedule and wherein the SD service schedule specifies that the target SD is to be removed after the target SD has been in service for the certain period of time;
after identifying the target SD, wherein the target SD is one of the N+M SDs:
receive a request to write data to the storage array;
in response to the request, write a Redundant Array of Independent Disks (RAID) stripe that consists of N−1 data blocks and M parity blocks to the storage array, wherein none of the N−1 data blocks are stored on the target SD and none of the M parity blocks are stored on the target SD;
perform a modified garbage collection operation, wherein the modified garbage collection operation comprises:
identifying a live RAID stripe in the storage array, wherein the live RAID stripe comprises second data and consists of N second data blocks and M second parity blocks;
writing a new RAID stripe to a new location in the storage array wherein the new RAID stripe consists of N−1 third data blocks and M third parity blocks, wherein at least one of the N−1 third data blocks comprises a copy of data in at least one of the N second data blocks; and
issue a removal notification when the modified garbage collection operation is completed, wherein the removal notification indicates that the target SD may be removed from the storage array.

12. (canceled)

13. (canceled)

14. (canceled)

15. The system of claim 11, wherein each of the N+M SDs comprises NAND flash.

16. The system of claim 11, further comprising:
a field programmable gate array (FPGA) configured to calculate a parity value for at least one of the M parity blocks in the RAID stripe.

17. The system of claim 11, wherein the storage controller is configured to track RAID stripe geometry for each of the plurality of live RAID stripes, wherein the RAID stripe geometry for each of the plurality of live RAID stripes is used to perform the modified garbage collection operation, wherein the live RAID stripe is one of the plurality of live RAID stripes.

18. The system of claim 11, wherein N≧2.

19. The system of claim 11, wherein M=1.

20. The system of claim 11, wherein M>1.
